(19) United States
(12) Patent Application Publication
(10) Pub. No.: US 2023/0376280 A1
(43) Pub. Date: Nov. 23, 2023

(54) METHODS, SYSTEMS AND COMPUTER PROGRAM PRODUCTS FOR OPTIMIZING COMPUTER PROGRAMMING FOR WORKFLOW DEVELOPMENT

(71) Applicant: Maira Inc., San Ramon, CA (US)

(72) Inventors: Ashish Ranjan, San Ramon, CA (US); Sachin Bansal, Fremont, CA (US)

(21) Appl. No.: 17/747,632

(22) Filed: May 18, 2022

(51) Int. Cl. G06F 8/34

(52) U.S. Cl. CPC G06F 8/34

(57) ABSTRACT

The invention provides a programming environment configured to receive programming inputs through a first GUI based graphic block programming interface and through a second textual code programming interface that is configured to enable input of textual code for adding to or modifying the workflow program application, and configured for displaying within the second textual coding interface, textual program code comprising, at least the segments of textual program code associated with each of the identified graphic blocks, wherein the textual program code is expressed in a high level programming language. The integrated developer environment additionally provides for implementing fault tolerant program code by providing for state save event triggers that initiate state save events, such that saved states corresponding to the state save events can be used to restart execution of an interrupted workflow program application from the point of interruption.

### FIELD OF THE INVENTION

The invention relates to the domain of workflow related computer programming. In particular, the invention provides methods, systems and computer program products for optimizing workflow development and implementation, and for enabling generation of failure tolerant and state-aware workflow related computer programming.

### BACKGROUND

Workflow automation related computer programming involves developing program code to implement automated workflow tasks. Unlike other more typical programming applications, workflow automation typically involves long running computer programs with human inputs at various stages. An example is automation of a food ordering and delivery workflow. Internally this involves multiple steps, from receiving/taking an order, scheduling with restaurants, pickup, delivery, payment and user feedback. Completion of each step may be over a considerable time duration, and may additionally rely on human inputs through a machine interface or a processor based interface. As a result, the workflow execution for such tasks must be resilient to system failures (e.g. software/hardware failures) as the chance of failure in a long running process can be high. Additionally, the program code for workflow automation tasks requires to be failure tolerant—so that if a programmed workflow is restarted after a failure event, it can resume from where it left off, to avoid undesired outcomes such as duplicate processes running in parallel, missed/duplicate billings etc.

Additionally, as businesses/workflow processes evolve, the developed workflows require to be modified or tweaked regularly. For business agility, these modifications are more often than not required to be made without involving the core engineering team. Because of this, ‘low code’ or ‘no code’ automation platforms are rapidly growing in popularity, which enables non-programmers (business and operations team) to independently adapt processes as business needs evolve.

The low code platform integrates with disparate systems (such as ordering, billing systems etc.) and offer these integrations as an easy to use set of libraries. These integrations are used as a set of drag-and-drop coding libraries available through a graphical user interface (GUI) or a web user interface (WebUI) for the purposes of generating an automated workflow.

At a high level, any automated workflow product has 3 components.
A library of commands to integrate/interact with various parts of the system.
A user interface (UI) or low level representation, for stitching the above low code library/commands into a logical series of actions.
An orchestration system which can execute the above workflow at scale in a fault tolerant manner.

Typically workflows are presented as a set of interconnected GUI blocks. For example in the illustrated workflow of FIG. 1, each graphic block/GUI block can be assumed to represent a set of executable commands. Outputs from the graphic blocks are ‘transformed’ before calling the next steps. These ‘transformations’ can also take ‘branching’ decisions as shown in the diagram.

FIG. 2 represents the machine executable commands/program code corresponding to the graphic blocks of FIG. 1. For example, the machine executable commands may comprise commands in a machine readable markup language like ‘YAML’ or other similar language. When a workflow that has been generated based on a selection of a set of graphic blocks (i.e. which are selected from a library of graphic blocks) is executed, the machine executable commands corresponding to each graphic block included in the workflow are retrieved and executed for the purposes of implementing the workflow.

However, graphic block coding platforms/low code platforms, in general, are deployed for applications/processes which change infrequently and/or for applications/processes of relatively lower complexity. For example factory floor processes may be changed once every month at best. In such cases it is acceptable to interact only through a GUI. However, if a target application could change frequently or many such applications are to be developed, GUI based coding quickly becomes a bottleneck. Likewise, while a relatively less complex workflow application may be generated through a graphic block coding platform/low code platform, as the workflow application grows in complexity, GUI based block coding becomes an impractical interface for programmers to develop and maintain program code through—since a GUI is generally inadequate to permit for complex development and maintenance tasks for program code. Yet another disadvantage associated with conventional graphic block coding platforms/low code platforms is that workflows created within a GUI cannot be shared easily—as they can only be executed within an orchestration system. Still further, keeping track of changes made on graphic block coding platforms is typically more difficult than tracking changes in text based program code—since comparison of graphic block based coding across different versions is more difficult and time consuming, when compared with checking for changes in text based program code.

Accordingly, while there may be existing products for enabling development of workflows and low code products, these solutions typically focus exclusively on use of GUI blocks, and as a result are impractical for developing or maintaining complex program logic, or program logic that changes frequently, or program logic that requires to be shared or easily executed or tested. Other solutions for workflow development involve general purpose programming languages—however implementation of any of these solutions necessitate expertise in the syntax of such general purpose programming languages, which presents difficulties for a non-programmer. As a result, automating workflows developed in a general purpose language quickly becomes very complex and requires ongoing investment to maintain them.

Additionally, programmers prefer to use computer languages/high level computer languages (like Python) to develop workflows. This enables them to rapidly and easily test and try workflow steps, in a command line interface (CLI) environment such as a unix shell (or in a web interface or a chat interface). Once validated, programmers would prefer to deploy the developed workflow without having to redo the programming steps in a GUI. Therefore in a multi-channel development environment, at least a sub-set of end users or programmers would prefer to be able to execute workflows that have been developed or that are under development within a CLI environment, or a chat console, as well as through a GUI.

In summary, existing approaches for low code programming/graphic block programming suffer from the following drawbacks:
As the low code program/playbook grows in size, it's hard to update especially if updates are frequent.
Developers/programmers don't want to drag/drop blocks to augment the playbook. They like to interact with the playbook ‘as code’.
Complex logics and transformation steps are not possible to develop/understand in a UI. e.g., in FIG. 2, it's quite cumbersome for humans to understand conditional (if/then) blocks. As workflow applications grow in complexity and size, interacting only in UI is not possible.
Workflow logic changes are very hard to understand from one version to another as presented in a UI.
The low code commands embedded in UI blocks are not easy to use on channels like UNIX shell, chat etc. e.g., the developer or operator cannot cut and paste from blocks to the debug console or share it over a chat.

There is accordingly a need for solutions that offer the advantages of graphic block coding/low code programming, while simultaneously addressing or eliminating bottlenecks that are generally associated with such coding. There is also a need for enabling development of complex automated workflows that can be generated, modified, tested, share and/or deployed rapidly. There is additionally a need for the developed workflows to be resilient to system failures, and for failure tolerant workflows that are capable of resuming seamlessly after a failure event.

### SUMMARY

The invention provides methods, systems and computer program products for optimizing workflow development and implementation, and for enabling generation of failure tolerant and state-aware workflow related computer programming.

The invention provides a method for generating textual program code within an integrated developer environment. The method comprises implementing at a processor, the steps of (i) generating within a transient memory, a programming environment configured to (a) receive programming inputs through a first GUI based graphic block programming interface that is configured to enable development of a graphical workflow representation of a workflow program application comprising a plurality of interconnected graphic blocks, and (b) receive programming inputs through a second textual code programming interface that is configured to enable input of textual code for adding to or modifying the workflow program application, (ii) receiving through the first GUI based graphic block programming interface, inputs identifying a plurality of graphic blocks for inclusion within the workflow program application, wherein each graphic block is associated with a segment of textual program code expressed in a machine compilable or machine interpretable programming language, (iii) displaying within the first GUI based graphic block programming interface, a graphical representation of the workflow program application as defined by the plurality of graphic blocks, (iv) displaying within the second textual coding interface, textual program code comprising, at least the segments of textual program code associated with each of the identified graphic blocks, wherein the textual program code is expressed in a high level programming language, and (v) retrievably storing in a non-transient memory, a record of the textual program code displayed in the second textual coding interface.

In an embodiment, the method, further comprises receiving through the first GUI based graphic block programming interface (i) inputs representing positional information identifying an absolute or relative position of the plurality of graphic blocks within the first GUI based graphic block programming interface, or (ii) inputs representing flow information identifying control flow, data flow or execution flow, between one or more of the plurality of graphic blocks.

The method may further comprise displaying within the second textual coding interface, program code for implementing control flow or data flow between the segments of textual program code associated with the graphic blocks.

In an embodiment of the method, the textual program code is expressed in a programming language capable of being interpreted or executed by a program code interpreter within the integrated development environment.

The invention additionally provides a method for modifying textual program code, comprising the steps of (i) retrieving from a non-transient memory, textual program code that has been generated within an integrated developer environment in accordance with the teachings of the present invention, (ii) receiving within the second textual coding interface, an input identifying addition, modification, or removal of an element of textual program code, (iii) displaying within the second textual coding interface, modified textual program code, wherein the modified textual program code includes added or modified textual program code, position information, and/or flow information, and unmodified elements of the textual program code, and excludes any removed elements of the textual program code, (iv) retrievably storing in non-transient memory, a record of the modified textual program code displayed in the second textual coding interface, and (v) modifying a graphical representation of a workflow program application corresponding to the retrieved textual program code, that is displayed in the first GUI based coding interface, wherein modifying the graphical representation of the workflow program application comprises adding, removing or modifying within said graphic representation, graphic block(s), positional information or flow information corresponding to any addition, removal or modification represented within the modified textual program code.

The invention provides an alternate method for modifying textual program code, comprising the steps of (i) retrieving from a non-transient memory, textual program code that has been generated within an integrated developer environment in accordance with the teachings of the present invention, (ii) receiving within the first GUI based graphic block programming interface, an input identifying addition, modification, or removal of any of a graphic block, position information or flow information, corresponding to a graphical representation of a workflow program application defined by the retrieved textual program code, (iii) displaying within the first GUI based coding interface, a modified graphical representation of the workflow program application, wherein the modified graphical representation includes any added or modified graphic block, position information or flow information, and unmodified elements of the graphical representation of the workflow program application, and excludes any removed elements, (iv) modifying displayed textual program code within the textual coding interface, wherein modifying the displayed textual program code comprises modifying textual program code associated with graphic blocks, positional information or flow information that has been modified in the graphical representation of the low code workflow program application, and (v) retrievably storing in non-transient memory, a record of the modified textual program code.

The invention provides a method of implementing failure tolerant program code comprising (i) initiating at a processor implemented interpreter, execution of textual program code corresponding to a workflow program application that has been generated within an integrated developer environment in accordance with the teachings of the present invention, wherein the interpreter is configured to identify one or more state save event triggers, (ii) responsive to detection of a state save event trigger associated with a program instruction within the textual program code (a) executing the program instruction, and (b) initiating a state save event for saving one or more data states associated with or resulting from execution of the program instruction, (c) recording the saved one or more data states in a memory, and (d) updating a data record identifying the program instruction associated with a most recently performed state save event.

This method may further comprise (i) restarting at the processor implemented interpreter, execution of textual program code corresponding to the workflow program application after occurrence of a program execution failure event or a program execution suspension event during execution of a previous instance of the workflow program application, (ii) retrieving a data record identifying a program instruction associated with a most recently performed state save event associated with the previous instance of the workflow program application, (iii) retrieving one or more saved data states arising from the previous instance of workflow application program, wherein said one or more saved data states have been saved in response to detection of a state save event trigger associated with a program instruction within the textual program code, and (iv) restarting execution of the workflow application program, wherein one or more program instructions executed subsequent to restarting execution of the workflow application program are performed based on or more of the retrieved data states.

In an embodiment of this method, execution of the workflow application program is restarted from a program instruction immediately succeeding the program instruction identified in the retrieved data record identifying a program instruction associated with a most recently performed state save event associated with the previous instance of the workflow program application.

The invention also provides A system for generating textual program code within an integrated developer environment. The system comprises at least one memory, and a processor configured for implementing the steps of (i) generating within a transient memory, a programming environment configured to (a) receive programming inputs through a first GUI based graphic block programming interface that is configured to enable development of a graphical workflow representation of a workflow program application comprising a plurality of interconnected graphic blocks, and (b) receive programming inputs through a second textual code programming interface that is configured to enable input of textual code for adding to or modifying the workflow program application, (ii) receiving through the first GUI based graphic block programming interface, inputs identifying a plurality of graphic blocks for inclusion within the workflow program application, wherein each graphic block is associated with a segment of textual program code expressed in a machine compilable or machine interpretable programming language, (iii) displaying within the first GUI based graphic block programming interface, a graphical representation of the workflow program application as defined by the plurality of graphic blocks, (iv) displaying within the second textual coding interface, textual program code comprising, at least the segments of textual program code associated with each of the identified graphic blocks, wherein the textual program code is expressed in a high level programming language, and (v) retrievably storing in a non-transient memory, a record of the textual program code displayed in the second textual coding interface.

The processor may be configured for receiving through the first GUI based graphic block programming interface (i) inputs representing positional information identifying an absolute or relative position of the plurality of graphic blocks within the first GUI based graphic block programming interface, or (ii) inputs representing flow information identifying control flow, data flow or execution flow, between one or more of the plurality of graphic blocks.

In an embodiment of the system, the processor may be configured for displaying within the second textual coding interface, program code for implementing control flow or data flow between the segments of textual program code associated with the graphic blocks.

In an further embodiment of the system, the textual program code is expressed in a programming language capable of being interpreted or executed by a program code interpreter within the integrated development environment.

The system may further be configured for modifying textual program code, by implementing the steps of (i) retrieving from a non-transient memory, textual program code that has been generated within the integrated developer environment, (ii) receiving within the second textual coding interface, an input identifying addition, modification, or removal of an element of textual program code, (iii) displaying within the second textual coding interface, modified textual program code, wherein the modified textual program code includes added or modified textual program code, position information, and/or flow information, and unmodified elements of the textual program code, and excludes any removed elements of the textual program code, (iv) retrievably storing in non-transient memory, a record of the modified textual program code displayed in the second textual coding interface, and (v) modifying a graphical representation of a workflow program application corresponding to the retrieved textual program code, that is displayed in the first GUI based coding interface, wherein modifying the graphical representation of the workflow program application comprises adding, removing or modifying within said graphic representation, graphic block(s), positional information or flow information corresponding to any addition, removal or modification represented within the modified textual program code.

In an embodiment, the system may be configured for modifying textual program code by implementing the steps of (i) retrieving from a non-transient memory, textual program code that has been generated within the integrated developer environment, (ii) receiving within the first GUI based graphic block programming interface, an input identifying addition, modification, or removal of any of a graphic block, position information or flow information, corresponding to a graphical representation of a workflow program application defined by the retrieved textual program code, (iii) displaying within the first GUI based coding interface, a modified graphical representation of the workflow program application, wherein the modified graphical representation includes any added or modified graphic block, position information or flow information, and unmodified elements of the graphical representation of the workflow program application, and excludes any removed elements, (iv) modifying displayed textual program code within the textual coding interface, wherein modifying the displayed textual program code comprises modifying textual program code associated with graphic blocks, positional information or flow information that has been modified in the graphical representation of the low code workflow program application, and (v) retrievably storing in non-transient memory, a record of the modified textual program code.

The invention also provides a system configured for implementing failure tolerant program code comprising at least one memory and a processor configured for implementing the steps of (i) initiating execution of textual program code corresponding to a workflow program application that has been generated within an integrated developer environment in accordance with the methods described in this written description, wherein the interpreter is configured to identify one or more tokens representing a state save instruction, (ii) responsive to detection of a state save event trigger associated with a program instruction within the textual program code (a) executing the program instruction, and (b) initiating a state save event for saving one or more data states associated with or resulting from execution of the program instruction, (c) recording the saved one or more data states in a memory, and (d) updating a data record identifying the program instruction associated with a most recently performed state save event.

In an embodiment of this system, the processor is configured for (i) restarting at the processor implemented interpreter, execution of textual program code corresponding to the workflow program application after occurrence of a program execution failure event or a program execution suspension event during execution of a previous instance of the workflow program application, (ii) retrieving a data record identifying a program instruction associated with a most recently performed state save event associated with the previous instance of the workflow program application, (iii) retrieving one or more saved data states arising from the previous instance of workflow application program, wherein said one or more saved data states have been saved in response to detection of a state save event trigger associated with a program instruction within the textual program code, and (iv) restarting execution of the workflow application program, wherein one or more program instructions executed subsequent to restarting execution of the workflow application program are performed based on or more of the retrieved data states.

In a further embodiment of this system the processor is configured such that execution of the workflow application program is restarted from a program instruction immediately succeeding the program instruction identified in the retrieved data record identifying a program instruction associated with a most recently performed state save event associated with the previous instance of the workflow program application.

The invention also provides a computer program product for generating textual program code within an integrated developer environment. The computer program product comprises a non-transitory computer usable medium having a computer readable program code embodied therein, the computer readable program code comprising instructions for implementing at a processor the steps of (i) generating within a transient memory, a programming environment configured to (a) receive programming inputs through a first GUI based graphic block programming interface that is configured to enable development of a graphical workflow representation of a workflow program application comprising a plurality of interconnected graphic blocks, and (b) receiving programming inputs through a second textual code programming interface that is configured to enable input of textual code for adding to or modifying the workflow program application, (ii) receiving through the first GUI based graphic block programming interface, inputs identifying a plurality of graphic blocks for inclusion within the workflow program application, wherein each graphic block is associated with a segment of textual program code expressed in a machine compilable or machine interpretable programming language, (iii) displaying within the first GUI based graphic block programming interface, a graphical representation of the workflow program application as defined by the plurality of graphic blocks, (iv) displaying within the second textual coding interface, textual program code comprising, at least the segments of textual program code associated with each of the identified graphic blocks, wherein the textual program code is expressed in a high level programming language, and (v) retrievably storing in a non-transient memory, a record of the textual program code displayed in the second textual coding interface.

### BRIEF DESCRIPTION OF THE ACCOMPANYING DRAWINGS

FIG. 1 illustrates an exemplary automated workflow of a kind that can be generated using graphic block based coding.

FIG. 2 illustrates exemplary program code of a kind that may be used to implement/executed workflow steps represented by one or more of the graphic blocks of FIG. 1.

FIG. 3 illustrates an exemplary interface implemented within an integrated development environment that is configured in accordance with the teachings of the present invention.

FIGS. 4A and 4B illustrate a method of generating executable program code within the integrated development environment of the present invention.

FIGS. 5 and 6 respectively illustrate methods of modifying program code that has been developed in accordance with the teachings of the present invention.

FIGS. 7 and 8 illustrate methods of implementing fault tolerant/failure tolerant program code in accordance with the teachings of the present invention.

FIG. 9 illustrates an integrated development environment platform configured in accordance with the teachings of the present invention.

FIG. 10 illustrates an exemplary system for implementing the present invention.

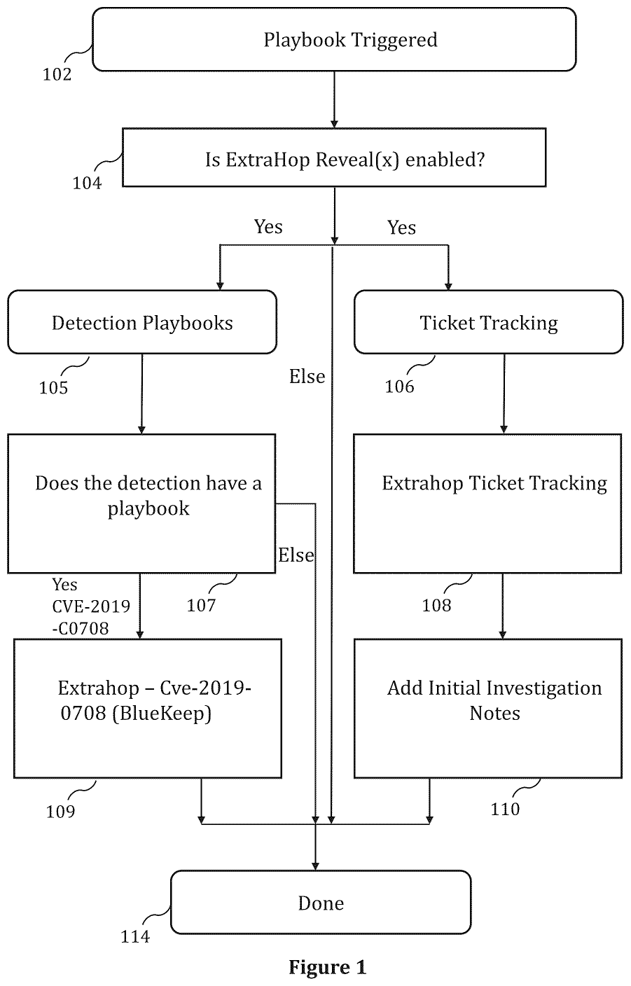

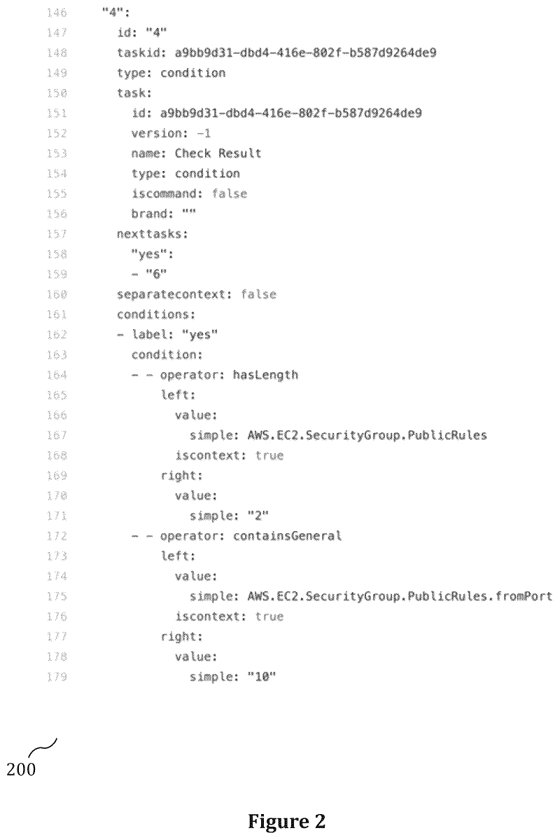

### DETAILED DESCRIPTION

The invention provides methods, systems and computer program products for optimizing workflow development and implementation, and for enabling generation of failure tolerant and state-aware workflow related computer programming. The invention provides a programming language for optimized workflow development and implementation. The programming language enables generation of failure tolerant and state-aware workflow related computer programming. Further, the programming language of the present invention enables development of workflow implementation program code that is capable of being tested or run within a command line interface, and that is not necessarily reliant on an orchestration platform for testing and/or execution. The invention also provides an integrated development environment that enables dual mode, or mixed mode, or hybrid mode programming—which allows users to selectively develop, generate or modify workflow related computer program code through either of a graphic block based programming or textual code based programming. The invention additionally provides a program code interpreter that is configured for executing program code written in the programming language of the present invention, in a state aware manner that enables saving of state data arising from workflow execution, and that enables restarting of a programmed workflow that has been terminated due to a failure event, from a workflow step for which state data has been saved during the terminated iteration of the programmed workflow.

The above embodiments of the invention are described in more detail below with reference to the accompanying drawings.

For the purposes of this written description, the term “low code” or “low code programming” refers to a programming approach where many of the integrations and code logics are already available as graphic blocks. Programmers or developers use these graphic blocks to build or define the workflow.

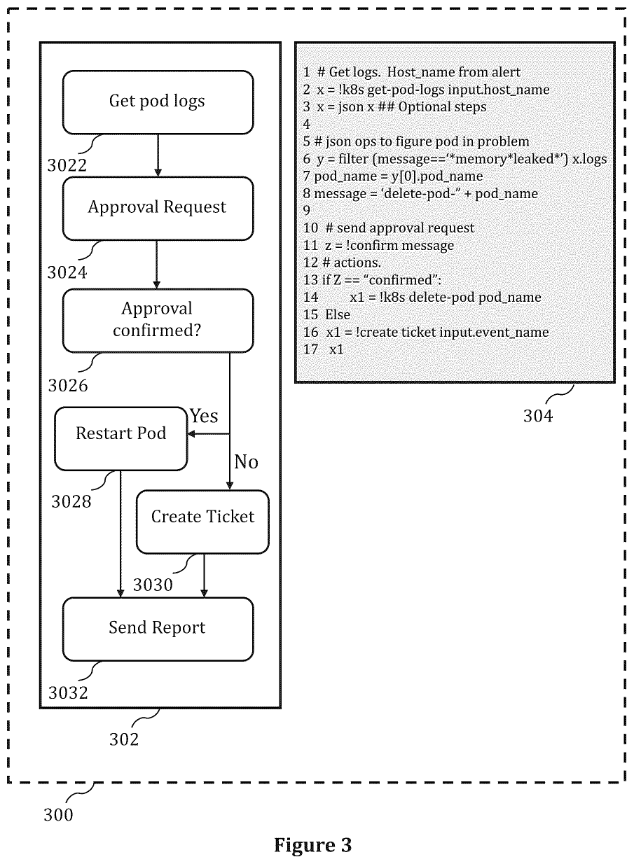

The invention provides a processor implemented integrated development environment that is configured to enable development of FIG. 3 illustrates an exemplary interface 300 implemented within an integrated development environment that is configured in accordance with the teachings of the present invention. Integrated development environment is configured to implement within interface 300, a first graphic block programming interface 302 and a second textual code programming interface 304. The first graphic block programming interface 302 is configured to enable a user or developer to develop a graphical workflow representation of a low code workflow program application comprising a plurality of interconnect graphic blocks 3022 to 3032. Each graphic block is selectable for inclusion and positioning within the first graphic block programming interface 302 from a library of graphic blocks. Additionally, each graphic block represents and/or is linked to a set of executable machine interpretable commands. The interconnections between the graphic blocks are also selectable/user editable and represent program flow, including any of data flow, control flow, and/or execution flow of the low code workflow program application. The graphic block programming interface 302 implemented by the integrated developer environment enables the non programmers to generate, maintain and execute low code workflows by interacting in a point-and-click manner/drag-and-drop manner with graphic block programming interface 302.

The second textual code programming interface 304 is configured to enable a user or developer to display the textual program code associated with a graphical workflow representation of a low code workflow, and to enable a user or developer to add or modify the textual code with a view to modify, refine or add to the low code workflow. In an illustrative embodiment, the textual program code is textual program code expressed in a high level programming language that has rules and/or syntax that is similar to, substantially similar to and/or consistent with rules/syntax of Python. The high level programming language enables programmers to code at a higher level of abstraction and to create and maintain software with complex logic. The high level programming language enables more complex or sophisticated program code than lower level languages such as YAML—where logic has to be expressed in blocks. The second textual code programming interface 304 is configured to display data structures and/or textual code corresponding to the graphical blocks displayed within graphic block programming interface 302, and/or textual code representing data flow, control flow, or execution flow between the graphic blocks displayed within graphic block programming interface 302, and/or textual code representing transformation steps between the data structures and/or textual code corresponding to the graphical blocks displayed within graphic block programming interface 302. The textual code displayed within the second textual code programming interface 304 comprises textual programming code in a programming language supported by the integrated development environment, and that is capable of being interpreted/executed by a program code interpreter within the integrated development environment. The transformation steps between the data structures and/or textual code corresponding to the graphical blocks displayed within graphic block programming interface 302 represent programming logic for process data that is output as a result of execution of program code corresponding to one graphic block and that is provided as input to program code corresponding to another graphic block.

The second textual code programming interface 304 is additionally configured to enable a user or developer to input textual code for adding to or modifying the low code workflow program application. The input textual code may define data structures and/or textual code corresponding to program operations or program functions that are to be added or modified within the low code workflow. The input textual code may also define data flow, control flow, or execution flow between the added or modified program operations or program functions transformation steps between the added or modified program operations or program functions.

The integrated development environment is configured such that responsive to any additions or modifications to the graphical workflow representation of a low code workflow program application, that are implemented through first graphic block programming interface 302, textual code representing said additions or modifications to the graphical workflow representation is correspondingly added or modified within the textual code associated said graphical workflow representation that is displayed within second textual code programming interface 304.

The integrated development environment may be configured to save the textual code associated with a graphical workflow representation of a low code workflow that has been developed or modified within interface 300, by retrievably storing in one or more data records, the textual code corresponding to said graphical workflow representation. The stored one or more data records, may optionally (but not necessarily) include data representing graphic blocks and/or interconnections therebetween that may be displayed within first graphic block programming interface 302 for the purposes of displaying a graphical workflow representation of the low code workflow program application. In some embodiments, the stored one or more data records do not include data representing graphic blocks and/or interconnections therebetween—and in such embodiments, displaying a graphical workflow representation of the low code workflow program application involves parsing the textual code corresponding to said graphical workflow representation and generating a graphical workflow representation based on the parsed textual code, which graphical workflow representation is then displayed within first graphic block programming interface 302 for the purposes of displaying a graphical workflow representation of the low code workflow program application.

Based on the above, it will be apparent that the graphical workflow representation and the textual program code respectively associated with a low code workflow program application, present two different options for a user or developer to interact with the workflow program application. The graphical workflow representation is generated in a manner that enables conversion into textual program code, for retrievable storage and subsequent execution of the textual program code for the purpose of executing the low code workflow program application.

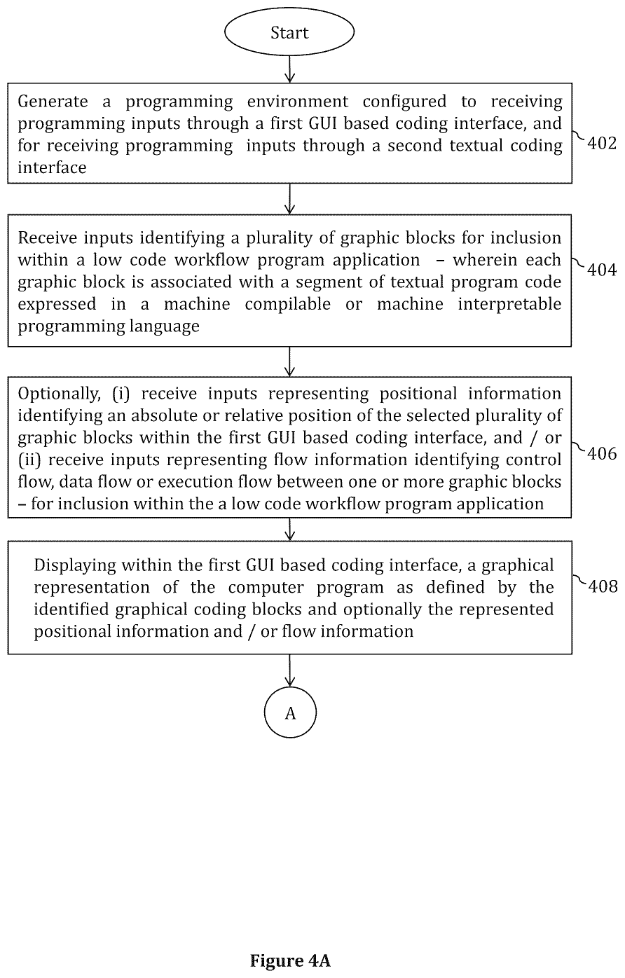

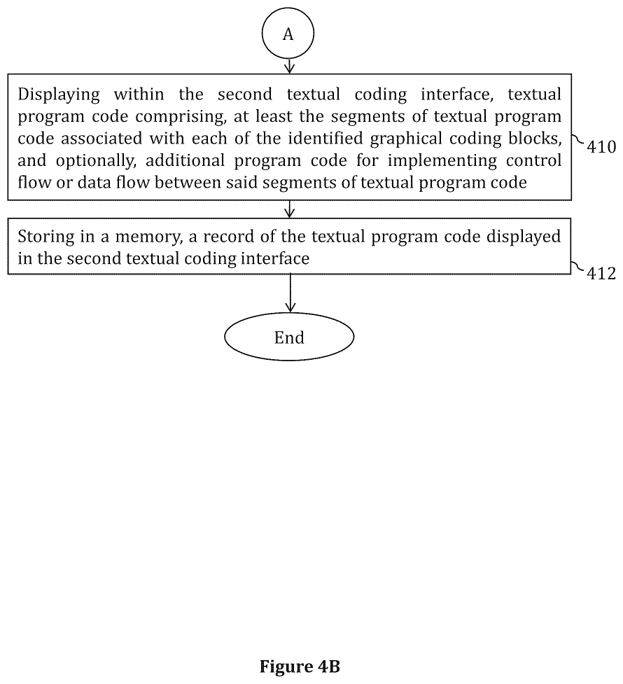

FIGS. 4A and 4B illustrate a method of generating executable program code within an integrated development environment of the present invention. The method of FIGS. 4A and 4B may be implemented within any processor implemented data processing device, including without limitation a computing device or server, or through the interactions between a plurality of networked or interconnected data processing devices.

Step 402 comprises generating a programming environment configured to receive programming inputs through a first GUI based coding interface, and for receiving programming inputs through a second textual coding interface. The programming environment may be generated within a transient memory or a volatile memory (such as random access memory (RAM)) for display on a display device or a user interface. In an embodiment, the programming environment generated at step 402 may comprise an integrated development environment (of the kind described in connection with FIG. 3 above). The first GUI based coding interface may comprise first graphic block programming interface 302, and may be configured to enable a user or developer to develop a graphical workflow representation of a low code workflow program application comprising a plurality of interconnected graphic blocks. The second textual coding interface may comprise second textual code programming interface 304 configured to enable a user or developer to input textual code for adding to or modifying the low code workflow program application.

Step 404 comprises receiving through the first GUI based coding interface, user or developer inputs identifying a plurality of graphic blocks, for inclusion within a low code workflow program application—wherein each graphic block is associated with a segment of textual program code expressed in a machine compilable or machine interpretable programming language.

Step 406 comprises optionally (i) receiving inputs representing positional information identifying an absolute or relative position of the selected plurality of graphic blocks within the first GUI based coding interface, and/or (ii) receiving inputs representing flow information identifying control flow, data flow or execution flow, between one or more graphic coding blocks—for inclusion within the low code workflow program application.

Step 408 comprises displaying within the first GUI based coding interface, a graphical representation of the low code workflow program application as defined by the identified graphic blocks and optionally the represented positional information and/or flow information.

Step 410 comprises displaying within the second textual coding interface, textual program code comprising, at least the segments of textual program code associated with each of the identified graphical coding blocks, and optionally, additional program code for implementing control flow or data flow between said segments of textual program code. The displayed textual program code comprises a textual code representation of the low code workflow program application, in a programming language supported by the integrated development environment, and that is capable of being interpreted/executed by a program code interpreter within the integrated development environment.

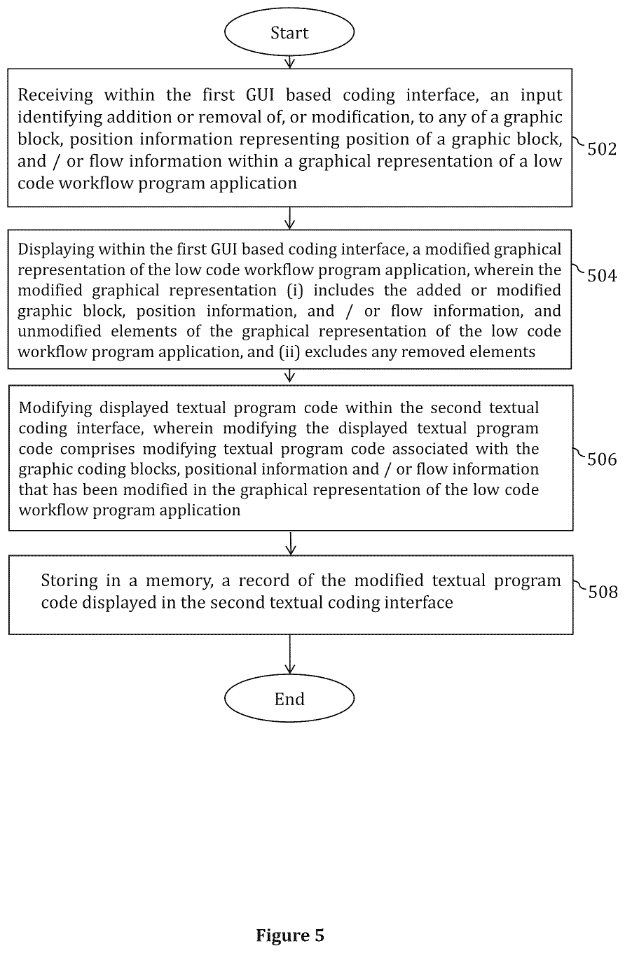

For the purposes of the present invention, including the descriptions in connection with FIGS. 4A and 4B, and the methods of FIGS. 5 to 8, it will be understood that the programming language in which the textual code can be written, and which an interpreter associated with the integrated development environment (or that is implemented within an integrated development environment 900) is a programming language having syntax that is capable of being executed or tested within a ‘read, evaluate, print loop’ (REPL) shell. In an embodiment, the programming language is a high-level, interpreted, general-purpose or specific purpose programming language. In another embodiment, the programming language is a high-level, interpreted, general-purpose or specific purpose programming language having syntax similar to the Python programming language. As a result, (i) textual code written in this programming language corresponding to the low code workflow program application can be readily tested, tried or shared in a shell, at a command line interface, in a shell-type chat interface etc, (ii) commands within the textual code written in this programming language corresponding to the low code workflow program application are not opaque strings insofar as the interpreter is concerned—and can therefore be executed on an orchestration system without the need to pre-install executables such as ‘curl’ that enable interpretation, (iii) textual code written in this programming language corresponding to the low code workflow program application enables easy deployment of rich access policy at command level—which enable offering of different execution privileges to different users, and thereby enables the operating environment to be secure and auditable, and (iv) textual code written in this programming language corresponding to the low code workflow program application enables automatic visibility of all operational changes carried out.

Step 412 comprises retrievably storing in a memory, a record of the textual program code displayed in the second textual coding interface. In an embodiment the memory within which the textual program code is stored is a non-transient or non-volatile memory (such as a hard drive, USB drive or other form of non-transient memory).

FIG. 5 illustrates a first method of modifying program code that has been developed in accordance with the teachings of the present invention. The method of FIG. 5 may be implemented within any processor implemented data processing device, including without limitation a computing device or server, or through the interactions between a plurality of networked or interconnected data processing devices. In an embodiment, the method of FIG. 5 may be implemented in connection with program code corresponding to a low code workflow program application that has been generated or developed according to the teachings of FIGS. 4A and 4B.

Step 502 comprises receiving within the first GUI based coding interface (in an embodiment, receiving within graphic block programming interface 302) an input identifying addition or removal of, or modification, to any of a graphic block, position information representing position of a graphic block, and/or flow information within a graphical representation of a low code workflow program application.

Step 504 comprises displaying within the first GUI based coding interface, a modified graphical representation of the low code workflow program application, wherein the modified graphical representation (i) includes the added or modified graphic block, position information, and/or flow information, and unmodified elements of the graphical representation of the low code workflow program application, and (ii) excludes any removed elements.

Step 506 comprises modifying displayed textual program code within the second textual coding interface, wherein modifying the displayed textual program code comprises modifying textual program code associated with the graphic blocks, positional information and/or flow information that has been modified in the graphical representation of the low code workflow program application.

Step 508 comprises retrievably storing in one or more data records within a memory, a record of the modified textual program code displayed in the second textual coding interface.

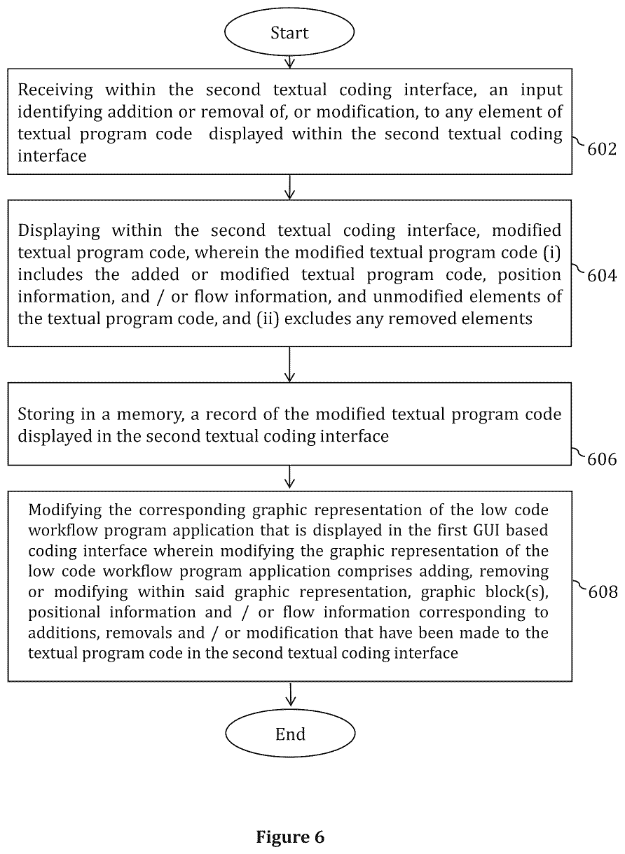

FIG. 6 illustrates a second method of modifying program code that has been developed in accordance with the teachings of the present invention. The method of FIG. 6 may be implemented within any processor implemented data processing device, including without limitation a computing device or server, or through the interactions between a plurality of networked or interconnected data processing devices. In an embodiment, the method of FIG. 5 may be implemented in connection with program code corresponding to a low code workflow program application that has been generated or developed according to the teachings of FIGS. 4A and 4B.

Step 602 comprises receiving within the second textual coding interface (in an embodiment, receiving within textual coding interface 304), an input identifying addition or removal of, or modification, to any element of textual program code displayed within the second textual coding interface.

Step 604 comprises displaying within the second textual coding interface, modified textual program code, wherein the modified textual program code (i) includes the added or modified textual program code, position information, and/or flow information, and unmodified elements of the textual program code, and (ii) excludes any removed elements

Step 606 comprises storing in one or more data records in a memory, a record of the modified textual program code displayed in the second textual coding interface.

Step 608 comprises modifying the corresponding graphic representation of the low code workflow program application that is displayed in the first GUI based coding interface (in an embodiment, within graphic block programming interface 302), wherein modifying the graphic representation of the low code workflow program application comprises adding, removing or modifying within said graphic representation, graphic block(s), positional information and/or flow information corresponding to additions, removals and/or modification that have been made to the textual program code in the second textual coding interface.

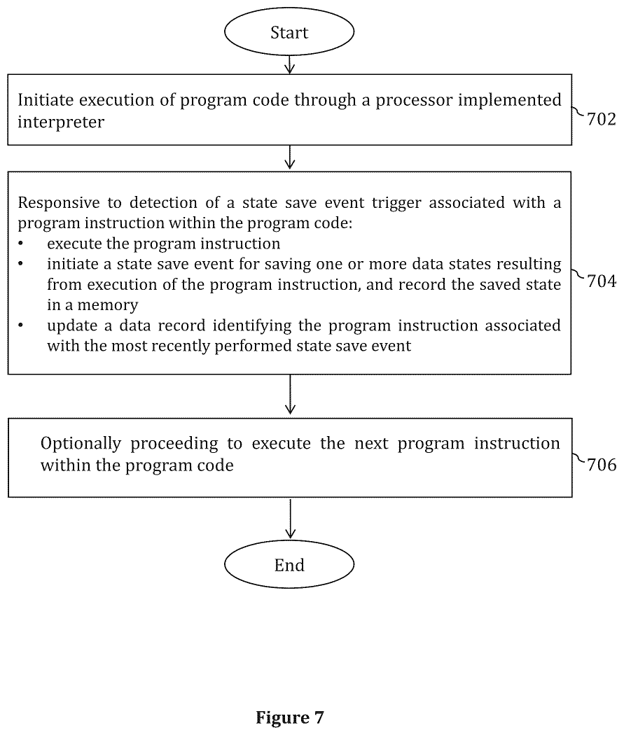

FIG. 7 illustrates a first method of implementing fault tolerant/failure tolerant program code in accordance with the teachings of the present invention. The method of FIG. 7 may be implemented within any processor implemented data processing device, including without limitation a computing device or server, or through the interactions between a plurality of networked or interconnected data processing devices.

Step 702 comprises initiating execution of program code from a low code workflow program application, through a processor implemented interpreter. In an embodiment, the interpreter may be implemented by or within an integrated development environment of the kind described above. In another embodiment, the interpreter may comprise a processor implemented implementer configured to interpret a programming language supported by or implemented by the integrated development environment. In yet another embodiment, the interpreter is a processor implemented interpreter configured to interpret the initiated program code. The interpreter is configured to identify and/or recognize one or state save event triggers associated with program instructions(s) within program code being executed. For the purposes of the invention, a state save event trigger comprises detection of any event that has been predefined as a trigger event for initiating a state save event. In an embodiment, the processor implemented interpreter may be configured to respond to detection of a state save event trigger associated with a program instruction by saving one or more data states resulting from execution of the program instruction in a memory, for subsequent retrieval and/or use. In an embodiment, the interpreter may be configured to identify and/or recognize as a state save event trigger:
detection or identification of one or more tokens, symbols, character strings, program code strings, processor commands, or system commands that are included within program code being executed, and that have been associated or linked with a state save instruction, and/or
detection or identification of one or more state change events, system events, system environment events or events that are external to a system or a system environment, that have been predefined or categorized as state save event triggers.

In an embodiment of the invention, one or more of program code strings, processor commands, or system commands that are recognized as a state save event trigger include program code strings, processor commands, or system commands (i) that are interpretable by the processor implemented interpreter associated with the integrated development environment, and (ii) that are also interpretable or executable by at least one command execution environment that is external to the integrated development environment (e.g. a unix shell environment). In an embodiment, the external command execution environment is implemented based on a first set of program code instructions and the integrated development environment is implemented based on a second set of program code instructions, wherein the first and second set of program code instructions are different from each other. In a further embodiment, (i) the external command execution environment uses a first sub-set of program code instructions within the first set of program code instructions, for executing the one or more of program code strings, processor commands, or system commands that are recognized as a state save event, (ii) (i) the processor implemented interpreter uses a second sub-set of program code instructions within the second set of program code instructions, for executing the one or more of program code strings, processor commands, or system commands that are recognized as a state save event, (iii) the first sub-set of program code instructions and the second sub-set of program code instructions are different from each other, and (iv) the one or more of program code strings, processor commands, or system commands that are recognized as a state save event trigger are compatible with both the first sub-set of program code instructions and the second sub-set of program code instructions.

In an embodiment of the invention, one or more of program code strings, processor commands, or system commands that are recognized as a state save event trigger comprise program code strings, processor commands, or system commands that conform to a command-line-interface type syntax supported by the high level programming language in which the textual program code is expressed or written.

An exemplary snippet of program code is reproduced below to illustrate the use of a state save instruction of the kind described in connection with step 702.

1 # Get logs. Host_name from alert
2 x = !k8s get-pod-logs input.host_name
3 x = json x ## Optional steps
4
5 # json ops to figure pod in problem
6 y = filter (message ==‘*memory*leaked*’) x.logs
7 pod_name = y[0].pod_name
8 message = ‘delete-pod-” + pod_name
9
10 # send approval request
11 z = !confirm message
12 # actions.
13 if Z == “confirmed”:
14 x1 = !k8s delete-pod pod_name
15 Else
16 x1 = !create ticket input.event_name
17 x1

In the above snippet of program code, the symbol ‘!’ represents a token or a symbol that has been associated or linked with a state save instruction, and which the interpreter is configured to recognize as a state save event trigger.

Step 704 comprises responding to detection of a state save event trigger prefixed to, or suffixed to, or associated with, or represented by a program instruction within the program code by (i) executing the program instruction, (ii) initiating a state save event for saving one or more data states associated with or resulting from execution of the program instruction, (iii) recording the saved state in a memory, and (iv) updating a data record identifying the program instruction associated with the most recently performed state save event.

Step 706 comprises optionally proceeding to execute the next program instruction within the program code.

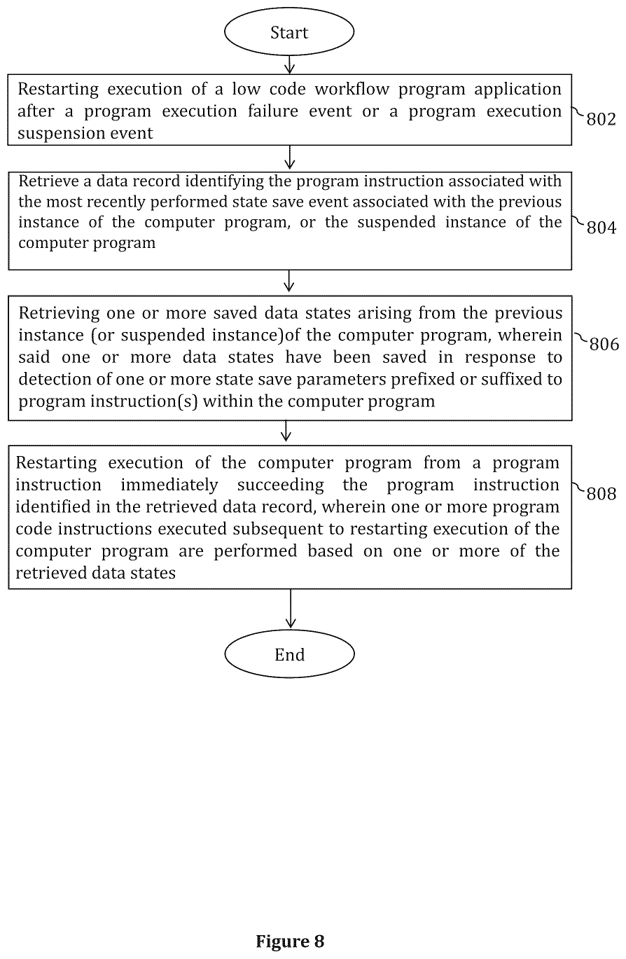

FIG. 8 illustrates a second method of implementing fault tolerant/failure tolerant program code in accordance with the teachings of the present invention. The method of FIG. 8 may be implemented within any processor implemented data processing device, including without limitation a computing device or server, or through the interactions between a plurality of networked or interconnected data processing devices.

Step 802 comprises restarting execution of a low code workflow program application, after occurrence of a program execution failure event during execution of a previous instance of the low code workflow program application. The program execution failure event may have occurred for any reason, including without limitation bugs in the program code or program code libraries, a system failure, hardware failure, operating system failure, power failure and/or operator initiated shutdown or task scheduler shutdown for maintenance or other reasons. In other embodiments, the restarting of execution of a low code workflow program application may occur after suspension of execution of an instance of the low code workflow program application (for example, in case of a voluntary suspension by an orchestrator or a load scheduler or batch processor or any other hardware or software controller, while the program application awaits data input from users or other input sources), and in which case restarting involves restarting the earlier suspended instance of the low code workflow program application. The step of restarting may be implemented by a processor implemented interpreter. In an embodiment, the interpreter may be implemented by or within an integrated development environment of the kind described above. In another embodiment, the interpreter may comprise a processor implemented implementer configured to interpret a programming language supported by or implemented by the integrated development environment. In yet another embodiment, the interpreter is a processor implemented interpreter configured to interpret the initiated program code. The interpreter is configured to identify and/or recognize one or more state save event triggers, of the kind described in connection with the method of FIG. 7, when such state save event trigger is included within program code that is being processed by the interpreter or occurs or arises as a result of execution of program code that is being processed by the interpreter.

Step 804 comprises retrieving a data record identifying the program instruction associated with the most recently performed state save event associated with the previous instance of the low code workflow program application (i.e. the instance of the low code workflow program application within which the program execution failure event has occurred or the instance of the low code workflow program application that was previously suspended and that has been subsequently restarted at the point of suspension).

Step 806 comprises retrieving at least one or more saved data states arising from the most recently executed instance of the low code workflow program application, wherein said one or more data states have been saved in response to detection of one or more state save event triggers that are prefixed to, or suffixed to, or associated with, or represented by a program instruction within the low code workflow program application (for example, in accordance with the method of FIG. 7). In a specific embodiment, step 806 comprises retrieving a plurality of (and optionally all of) the saved data states generated from the most recently executed instance of the low code workflow program application, wherein each retrieved saved data state has been generated in response to a state save event trigger detected during execution of program code within the most recently executed instance of the low code workflow program application.

Step 808 comprises restarting execution of the low code workflow program application from a program instruction immediately succeeding the program instruction identified in the retrieved data record, wherein one or more program code instructions executed subsequent to restarting execution of the computer program are performed based on one or more of the retrieved data states. In an embodiment, where step 806 comprises retrieving a plurality of (and optionally all of) the saved data states generated from the most recently executed instance of the low code workflow program application, restarting execution of the low code workflow program application may be performed based on one or more than one of the retrieved plurality of saved data states.

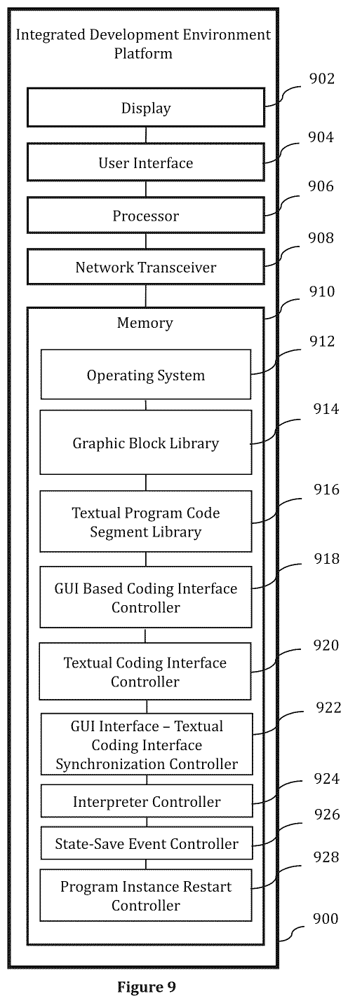

FIG. 9 illustrates an integrated development environment platform 900 configured in accordance with the teachings of the present invention.

As shown in FIG. 9, integrated development environment platform 900 includes (i) a display 902, (ii) a user interface 904, (iii) a processor 906, (iv) optionally a network transceiver 908 configured to enable transmission and receiving of network communications, and (v) a memory 910.

In an exemplary embodiment, memory 910 may have stored therewithin, one or more of (i) an operating system 912 configured for managing device hardware and software resources and that provides common services for software programs implemented within integrated development environment platform 900, (ii) a graphic block library 914—comprising a plurality of selectable graphic blocks from which a user or developer may select through a first graphic block programming interface (e.g. interface 302) for developing a graphical workflow representation of a low code workflow program application, (iii) a textual program code segment library 916—comprising a library of segments of textual program code—wherein each segment of textual program code is program code associated with a corresponding graphic block stored within the graphic block library 914, (iv) a processor implemented GUI based coding interface controller 918 configured to implement the functionality of the first graphic block programming interface 302 as described hereinabove, (v) a processor implemented textual coding interface controller 920 configured to implement the functionality of the second textual code programming interface 304 described above, (vi) a GUI Interface—Textual Coding Interface Synchronization Controller 922 configured such that responsive to any additions or modifications to the graphical workflow representation of a low code workflow program application, that are implemented through first graphic block programming interface 302, textual code representing said additions or modifications to the graphical workflow representation is correspondingly added or modified within the textual code associated said graphical workflow representation that is displayed within second textual code programming interface 304, (vii) a processor implemented interpreter controller 924 configured to control the functionality of a program code interpreter that is implemented by or within the integrated development environment platform 900, and/or that has been configured to implement the functionality of the integrated development environment that has been described hereinabove, and/or that has been configured to implement any one or more of steps 702 to 706 of the method of FIG. 7 or any of steps 802 to 808 of the method of FIG. 8, (viii) a processor implemented state-save event controller 926 that has been configured to implement any one or more of steps 704 to 706 of the method of FIG. 7, and/or (ix) a processor implemented program instance restart controller 928 that has been configured to implement any of steps 802 to 808 of the method of FIG. 8.

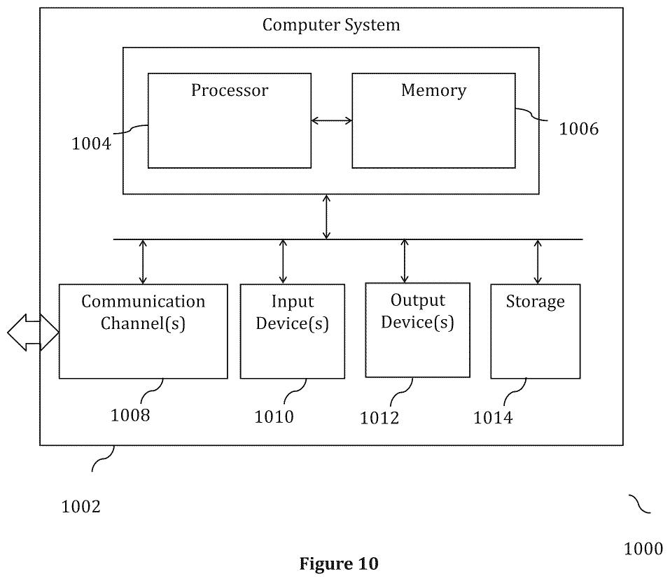

FIG. 10 illustrates an exemplary system for implementing the present invention.

The system of FIG. 10 comprises a computer system 1002 which in turn comprises one or more processors 1004 and at least one memory 1006. Processor 1004 is configured to execute program instructions—and may be a real processor or a virtual processor. It will be understood that computer system 1002 does not suggest any limitation as to scope of use or functionality of described embodiments. The computer system 1002 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1002 in accordance with the present invention may include one or more servers, desktops, laptops, tablets, smart phones, mobile phones, mobile communication devices, tablets, phablets and personal digital assistants. In an embodiment of the present invention, the memory 1006 may store software for implementing various embodiments of the present invention. The computer system 1002 may have additional components. For example, the computer system 1002 may include one or more communication channels 1008, one or more input devices 1010, one or more output devices 1012, and storage 1014. An interconnection mechanism (not shown) such as a bus, controller, or network, interconnects the components of the computer system 1002. In various embodiments of the present invention, operating system software (not shown) provides an operating environment for various software executing in the computer system 1002 using a processor 1004, and manages different functionalities of the components of the computer system 1002.

The communication channel(s) 1008 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1010 may include, but is not limited to, a touch screen, a keyboard, mouse, pen, joystick, trackball, a voice device, a scanning device, or any another device that is capable of providing input to the computer system 1002. In an embodiment of the present invention, the input device(s) 1010 may be a sound card or similar device that accepts audio input in analog or digital form. The output device(s) 1012 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1002.

The storage 1014 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1002. In various embodiments of the present invention, the storage 1014 may contain program instructions for implementing any of the described embodiments.

In an embodiment of the present invention, the computer system 1002 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1002. The method described herein is typically implemented as a computer program product, comprising a set of program instructions that is executed by the computer system 1002 or any other similar device. The set of program instructions may be a series of computer readable codes stored on a tangible medium, such as a computer readable storage medium (storage 1014), for example, diskette, CD-ROM, ROM, flash drives or hard disk, or transmittable to the computer system 1002, via a modem or other interface device, over either a tangible medium, including but not limited to optical or analogue communications channel(s) 1008. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be understood that the present invention provides solutions that (i) simultaneously offer the advantages of graphic block coding low code workflow programming, as well as textual coding for low code workflow programming, (ii) enable development of complex automated workflows that can be generated, modified, tested, share and/or or deployed rapidly, and (iii) enable developed workflows to be resilient to system failures, and for generating failure tolerant workflows that are capable of resuming seamlessly after a failure event.

In particular, execution of program code generated within the integrated development environment of the present invention, and/or in accordance with the methods of the present invention differs from execution of program code developed using conventional graphic block coding platforms/low code platforms. Execution of program code developed using conventional graphic block coding platforms/low code platforms involves interpretation and execution of the block representations associated with such program code—by identifying each block and calling on the library file/data file associated with such block. In contrast, execution of program code generated within the integrated development environment of the present invention involves directly interpreting and executing the textual program code stored in the one or more data records—and does not involve parsing/interpreting the blocks themselves.

The use of textual program code developed in a high level programming language to express, store, retrieve, interpret and/or execute a program application, give users or programmers significantly greater freedom and ease to express complex logic. High level programming languages provide a familiar environment for developers who develop sophisticated tools and software, and is preferred by programmers over low level programming languages for the reason that it enables software development at a significantly higher level of abstraction. As a result, the integrated development environment of the present invention offers several advantages of the conventionally known YAML based graphic block coding platforms/low code platforms where (i) even simple coding tasks are time consuming due to the need to approach such tasks through a GUI, and (ii) complex coding tasks are even more cumbersome in a GUI, since creating the programming logic in the GUI requires the user/programmer to manually connect huge number of blocks to create the program logic.

The integrated development environment and associated methods of the present invention also provide for advantages over approaches that rely solely on textual code based programming involving coding solely in a high level general purpose programming language such as Python, Java, JavaScript, Golang etc. Coding solely in a high level general purpose programming language has multiple disadvantages including:
presenting difficulties in determining what state to save for state aware workflow restartability,
a general purpose high level language exposing too many complex features/libraries, which results in high maintenance cost of the resulting workflows, and/or
the resulting program code cannot be tested in an easy/straightforward manner, since the code may not be inherently supported as a command within a shell environment. One of the reasons for this is that program code written in a high level general purpose programming language does not abstract out workflow steps from surrounding code logic in a manner that can be independently tried or tested in a shell or an integrated developer environment.

Generation of workflow program code within the integrated development environment of the present invention addresses these disadvantages.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

We claim:

1. A method for generating textual program code within an integrated developer environment, the method comprising implementing at a processor, the steps of:
generating within a transient memory, a programming environment configured to:
receive programming inputs through a first GUI based graphic block programming interface that is configured to enable development of a graphical workflow representation of a workflow program application comprising a plurality of interconnected graphic blocks; and
receive programming inputs through a second textual code programming interface that is configured to enable input of textual code for adding to or modifying the workflow program application;
receiving through the first GUI based graphic block programming interface, inputs identifying a plurality of graphic blocks for inclusion within the workflow program application, wherein each graphic block is associated with a segment of textual program code expressed in a machine compilable or machine interpretable programming language;
displaying within the first GUI based graphic block programming interface, a graphical representation of the workflow program application as defined by the plurality of graphic blocks;
displaying within the second textual coding interface, textual program code comprising, at least the segments of textual program code associated with each of the identified graphic blocks, wherein the textual program code is expressed in a high level programming language; and
retrievably storing in a non-transient memory, a record of the textual program code displayed in the second textual coding interface.

2. The method as claimed in claim 1, further comprising receiving through the first GUI based graphic block programming interface:
inputs representing positional information identifying an absolute or relative position of the plurality of graphic blocks within the first GUI based graphic block programming interface; or
inputs representing flow information identifying control flow, data flow or execution flow, between one or more of the plurality of graphic blocks.

3. The method as claimed in claim 1, further comprising displaying within the second textual coding interface, program code for implementing control flow or data flow between the segments of textual program code associated with the graphic blocks.

4. The method as claimed in claim 1, wherein the textual program code is expressed in a programming language capable of being interpreted or executed by a program code interpreter within the integrated development environment.

5. A method for modifying textual program code, comprising the steps of:
retrieving from a non-transient memory, textual program code that has been generated within an integrated developer environment in accordance with the method of claim 1;
receiving within the second textual coding interface, an input identifying addition, modification, or removal of an element of textual program code;
displaying within the second textual coding interface, modified textual program code, wherein the modified textual program code includes added or modified textual program code, position information, and/or flow information, and unmodified elements of the textual program code, and excludes any removed elements of the textual program code;
retrievably storing in non-transient memory, a record of the modified textual program code displayed in the second textual coding interface; and
modifying a graphical representation of a workflow program application corresponding to the retrieved textual program code, that is displayed in the first GUI based coding interface, wherein modifying the graphical representation of the workflow program application comprises adding, removing or modifying within said graphic representation, graphic block(s), positional information or flow information corresponding to any addition, removal or modification represented within the modified textual program code.

6. A method for modifying textual program code, comprising the steps of:
retrieving from a non-transient memory, textual program code that has been generated within an integrated developer environment in accordance with the method of claim 1;
receiving within the first GUI based graphic block programming interface, an input identifying addition, modification, or removal of any of a graphic block, position information or flow information, corresponding to a graphical representation of a workflow program application defined by the retrieved textual program code;
displaying within the first GUI based coding interface, a modified graphical representation of the workflow program application, wherein the modified graphical representation includes any added or modified graphic block, position information or flow information, and unmodified elements of the graphical representation of the workflow program application, and excludes any removed elements;
modifying displayed textual program code within the textual coding interface, wherein modifying the displayed textual program code comprises modifying textual program code associated with graphic blocks, positional information or flow information that has been modified in the graphical representation of the low code workflow program application; and
retrievably storing in non-transient memory, a record of the modified textual program code.

7. A method of implementing failure tolerant program code comprising:
initiating at a processor implemented interpreter, execution of textual program code corresponding to a workflow program application that has been generated within an integrated developer environment in accordance with the method of claim 1, wherein the interpreter is configured to identify one or more tokens representing a state save instruction;
responsive to detection of a state save event trigger associated with a program instruction within the textual program code:
executing the program instruction; and
initiating a state save event for saving one or more data states associated with or resulting from execution of the program instruction;
recording the saved one or more data states in a memory; and
updating a data record identifying the program instruction associated with a most recently performed state save event.

8. The method as claimed in claim 7, comprising:
restarting at the processor implemented interpreter, execution of textual program code corresponding to the workflow program application after occurrence of a program execution failure event or a program execution suspension event during execution of a previous instance of the workflow program application;
retrieving a data record identifying a program instruction associated with a most recently performed state save event associated with the previous instance of the workflow program application;
retrieving one or more saved data states arising from the previous instance of workflow application program, wherein said one or more saved data states have been saved in response to detection of a state save event trigger associated with a program instruction within the textual program code; and
restarting execution of the workflow application program, wherein one or more program instructions executed subsequent to restarting execution of the workflow application program are performed based on or more of the retrieved data states.

9. The method as claimed in claim 8, wherein execution of the workflow application program is restarted from a program instruction immediately succeeding the program instruction identified in the retrieved data record identifying a program instruction associated with a most recently performed state save event associated with the previous instance of the workflow program application.

10. A system for generating textual program code within an integrated developer environment, the system comprising:
at least one memory; and
a processor configured for implementing the steps of:
generating within a transient memory, a programming environment configured to:
receive programming inputs through a first GUI based graphic block programming interface that is configured to enable development of a graphical workflow representation of a workflow program application comprising a plurality of interconnected graphic blocks; and
receive programming inputs through a second textual code programming interface that is configured to enable input of textual code for adding to or modifying the workflow program application;
receiving through the first GUI based graphic block programming interface, inputs identifying a plurality of graphic blocks for inclusion within the workflow program application, wherein each graphic block is associated with a segment of textual program code expressed in a machine compilable or machine interpretable programming language;
displaying within the first GUI based graphic block programming interface, a graphical representation of the workflow program application as defined by the plurality of graphic blocks;
displaying within the second textual coding interface, textual program code comprising, at least the segments of textual program code associated with each of the identified graphic blocks, wherein the textual program code is expressed in a high level programming language; and
retrievably storing in a non-transient memory, a record of the textual program code displayed in the second textual coding interface.

11. The system as claimed in claim 10, wherein the processor is configured for receiving through the first GUI based graphic block programming interface:
inputs representing positional information identifying an absolute or relative position of the plurality of graphic blocks within the first GUI based graphic block programming interface; or
inputs representing flow information identifying control flow, data flow or execution flow, between one or more of the plurality of graphic blocks.

12. The system as claimed in claim 10, wherein the processor is configured for displaying within the second textual coding interface, program code for implementing control flow or data flow between the segments of textual program code associated with the graphic blocks.

13. The system as claimed in claim 10, wherein the textual program code is expressed in a programming language capable of being interpreted or executed by a program code interpreter within the integrated development environment.

14. The system as claimed in claim 10, further configured for modifying textual program code, by implementing the steps of:
retrieving from a non-transient memory, textual program code that has been generated within the integrated developer environment;
receiving within the second textual coding interface, an input identifying addition, modification, or removal of an element of textual program code;
displaying within the second textual coding interface, modified textual program code, wherein the modified textual program code includes added or modified textual program code, position information, and/or flow information, and unmodified elements of the textual program code, and excludes any removed elements of the textual program code;
retrievably storing in non-transient memory, a record of the modified textual program code displayed in the second textual coding interface; and
modifying a graphical representation of a workflow program application corresponding to the retrieved textual program code, that is displayed in the first GUI based coding interface, wherein modifying the graphical representation of the workflow program application comprises adding, removing or modifying within said graphic representation, graphic block(s), positional information or flow information corresponding to any addition, removal or modification represented within the modified textual program code.

15. The system as claimed in claim 10, further configured for modifying textual program code by implementing the steps of:
retrieving from a non-transient memory, textual program code that has been generated within the integrated developer environment;
receiving within the first GUI based graphic block programming interface, an input identifying addition, modification, or removal of any of a graphic block, position information or flow information, corresponding to a graphical representation of a workflow program application defined by the retrieved textual program code;
displaying within the first GUI based coding interface, a modified graphical representation of the workflow program application, wherein the modified graphical representation includes any added or modified graphic block, position information or flow information, and unmodified elements of the graphical representation of the workflow program application, and excludes any removed elements;
modifying displayed textual program code within the textual coding interface, wherein modifying the displayed textual program code comprises modifying textual program code associated with graphic blocks, positional information or flow information that has been modified in the graphical representation of the low code workflow program application; and
retrievably storing in non-transient memory, a record of the modified textual program code.

16. A system configured for implementing failure tolerant program code comprising:
at least one memory;
a processor configured for implementing the steps of:
initiating execution of textual program code corresponding to a workflow program application that has been generated within an integrated developer environment in accordance with the method of claim 1, wherein the interpreter is configured to identify one or more tokens representing a state save instruction;
responsive to detection of a state save event trigger associated with a program instruction within the textual program code:
executing the program instruction; and
initiating a state save event for saving one or more data states associated with or resulting from execution of the program instruction;
recording the saved one or more data states in a memory; and
updating a data record identifying the program instruction associated with a most recently performed state save event.

17. The system as claimed in claim 16, wherein the processor is configured for:
restarting at the processor implemented interpreter, execution of textual program code corresponding to the workflow program application after occurrence of a program execution failure event or a program execution suspension event during execution of a previous instance of the workflow program application;
retrieving a data record identifying a program instruction associated with a most recently performed state save event associated with the previous instance of the workflow program application;
retrieving one or more saved data states arising from the previous instance of workflow application program, wherein said one or more saved data states have been saved in response to detection of a state save event trigger associated with a program instruction within the textual program code; and
restarting execution of the workflow application program, wherein one or more program instructions executed subsequent to restarting execution of the workflow application program are performed based on or more of the retrieved data states.

18. The system as claimed in claim 17, wherein the processor is configured such that execution of the workflow application program is restarted from a program instruction immediately succeeding the program instruction identified in the retrieved data record identifying a program instruction associated with a most recently performed state save event associated with the previous instance of the workflow program application.

19. A computer program product for generating textual program code within an integrated developer environment, comprising a non-transitory computer usable medium having a computer readable program code embodied therein, the computer readable program code comprising instructions for implementing at a processor the steps of:
generating within a transient memory, a programming environment configured to:
receive programming inputs through a first GUI based graphic block programming interface that is configured to enable development of a graphical workflow representation of a workflow program application comprising a plurality of interconnected graphic blocks; and
receive programming inputs through a second textual code programming interface that is configured to enable input of textual code for adding to or modifying the workflow program application;
receiving through the first GUI based graphic block programming interface, inputs identifying a plurality of graphic blocks for inclusion within the workflow program application, wherein each graphic block is associated with a segment of textual program code expressed in a machine compilable or machine interpretable programming language;
displaying within the first GUI based graphic block programming interface, a graphical representation of the workflow program application as defined by the plurality of graphic blocks;
displaying within the second textual coding interface, textual program code comprising, at least the segments of textual program code associated with each of the identified graphic blocks, wherein the textual program code is expressed in a high level programming language; and
retrievably storing in a non-transient memory, a record of the textual program code displayed in the second textual coding interface.
